(19) United States
(12) Patent Application Publication
(10) Pub. No.: US 2011/0188924 A1
(43) Pub. Date: Aug. 4, 2011

(54) PANEL CLAMP ASSEMBLY HAVING A PRIMARY PANEL CLAMP AND A SECONDARY PANEL CLAMP RELEASABLEY-CONNECTED TO THE PRIMARY PANEL CAMP

(76) Inventor: Scott WINTER, Annandale, VA (US)

(21) Appl. No.: 12/700,327

(22) Filed: Feb. 4, 2010

(51) Int. Cl. F16B 5/06; F16C 11/04

(52) U.S. Cl. 403/79; 403/338

(57) ABSTRACT

A panel clamp assembly includes a primary panel clamp and at least one secondary panel clamp releasably-connected to the primary panel clamp. The primary panel clamp includes a clamp member having a pair of jaws and a web interconnecting the pair of jaws to each other in a manner to form a generally U-shaped configuration and to define a channel therebetween and a support member extending longitudinally and parallel to the web and connected to the clamp member. The at least one secondary panel clamp includes a clamp member, similar to the one above, and at least one hook-shaped fastener connected to the clamp member and sized and adapted to be releasably connected to the support member of the primary panel clamp.

### FIELD OF THE INVENTION

The present invention relates to a panel clamp assembly. More particularly, the present invention is directed to a panel clamp assembly having a primary panel clamp and at least one secondary panel clamp releasably connected to the primary panel clamp.

### BACKGROUND OF THE INVENTION

Panel clamp assemblies are commonly known in the art.

For example, U.S. Pat. No. 6,546,675 to Adderton teaches a supported panel assembly that includes a panel, a pair of spaced-apart panel support assemblies, a post and an elongate panel edge receiving member. The panel has first and second parallel edges and two opposite sides. The pair of spaced-apart panel support assemblies supports respective first and second edges. Each panel support assembly includes a post and an elongate panel edge receiving member. The post has an elongate laterally opening part cylindrical recess extending along its length. The elongate panel edge receiving member has internal walls defining a U-shaped laterally opening channel extending along its length and an outer peripheral wall shaped so as to allow rotation with the recess about a lengthwise axis of the post. The channel is sized to receive an edge of the panel with a clearance fit. The clearance fit has a gap between one of the sides of the panel and the U-shaped channel. The receiving member has a diameter. After fixing the posts in a spaced-apart parallel relationship, the first edge of the panel is movable into a first of the pair of channels in a direction perpendicular to the respective lengthwise axis and subsequently the panel edge and the receiving member can be rotated about the respective lengthwise axis together to allow insertion of the second edge of the panel into the receiving member of the second panel support assembly while the first edge remains within the first channel.

U.S. Pat. No. 4,968,171 to Shell teaches a hingeless connector assembly for joining one or more similar connector assemblies to form a hingeless post assembly for a modular display system. Each connector assembly includes an elongated member having a first connector adapted for attachment thereto of a flat panel, a second connector for interlockingly attaching up to four adjoining connector assemblies and a plate member disposed between the first and second connectors. The second connector includes a cylindrical member having a substantially circular cross-sectional shape and a groove member having a cup-like cross-sectional shape extending outward from the plate of the connector assembly in a parallel manner with a space therebetween. The cylindrical member in cross section has a first portion extending substantially perpendicularly from the plate member, a second straight portion connected to the first portion with an angle therebetween and a third portion having a circularly-shaped member which is connected to the second straight portion.

### SUMMARY OF THE INVENTION

A panel clamp assembly of the present invention includes a primary panel clamp and at least one secondary panel clamp. The primary panel clamp includes primary panel clamp member, a pair of connector elements and a support member. The primary panel clamp member extends along and about a first longitudinal axis and has a pair of primary panel jaws and a primary panel web. The primary panel web interconnects the pair of primary panel jaws to each other in a manner to form a generally U-shaped configuration and to define a channel between and among the pair of primary panel jaws and the primary panel web. The pair of connector elements is disposed apart from one another and is connected to the primary panel web. The support member extends longitudinally and parallel to the primary panel web. The support member is connected adjacent the primary panel web in a spaced-apart manner and the pair of connector elements interconnects the support member and primary panel clamp member.

The at least one secondary panel clamp includes a secondary panel clamp member and at least one hook-shaped fastener. The secondary panel clamp member extends along and about a second longitudinal axis that extends parallel to the first longitudinal axis. The secondary panel clamp member has a pair of secondary panel jaws and a secondary panel web that interconnects the pair of secondary panel jaws to each other in a manner to form a generally U-shaped configuration and to define a channel between and among the pair of secondary panel jaws and the secondary panel web.

The at least one hook-shaped fastener has a first end and extending therefrom to terminate in a free end portion. The at least one hook-shaped fastener has an inner fastener surface defining a passageway extending along and about a passageway axis through the hook-shaped fastener with an opening into the passageway. The at least one hook-shaped fastener is connected to the secondary panel web at the first end. The passageway axis is oriented parallel to the second longitudinal axis. The at least one hook-shaped fastener is sized to receive the support member through the opening and releasably retain the support member in the passageway in a close-fitting manner.

The present invention will be better appreciated in view of the detailed description of the exemplary embodiments of the present invention with reference to the accompanying drawings, in which:

### BRIEF DESCRIPTION OF THE DRAWINGS

FIG. 1 is a perspective view of a first exemplary embodiment of a panel clamp assembly of the present invention having a primary panel clamp and a secondary panel clamp releasably connected together.

FIG. 2 is an exploded perspective view of the first exemplary embodiment of the panel clamp assembly in FIG. 1 having the primary panel clamp and the secondary panel clamp disconnected from one another.

FIG. 3 is a side elevational view of the primary panel clamp of the first exemplary embodiment of the panel clamp assembly.

FIG. 4 is a front elevational view of the primary panel clamp of the first exemplary embodiment of the panel clamp assembly.

FIG. 5 is a rear elevational view of the primary panel clamp of the first exemplary embodiment of the panel clamp assembly.

FIG. 6 is a top planar view of the primary panel clamp of the first exemplary embodiment of the panel clamp assembly.

FIG. 7 is a side elevational view of the secondary panel clamp of the first exemplary embodiment of the panel clamp assembly.

FIG. 8 is a front elevational view of the secondary panel clamp of the first exemplary embodiment of the panel clamp assembly.

FIG. 9 is a rear elevational view of the secondary panel clamp of the first exemplary embodiment of the panel clamp assembly.

FIG. 10 is a top planar view of the secondary panel clamp of the first exemplary embodiment of the panel clamp assembly.

FIG. 11 is a perspective view of a second exemplary embodiment of the panel clamp assembly of the present invention having a primary panel clamp with a first secondary panel clamp, a second secondary panel clamp and a third secondary panel clamp releasably connected to the primary panel clamp.

FIG. 12 is a side elevational view of the second exemplary embodiment of the panel clamp assembly.

FIG. 13 is a top planar view of the second exemplary embodiment of the panel clamp assembly.

FIG. 14 is a diagrammatical view of the second exemplary embodiment of the panel clamp assembly illustrating a first arrangement of a plurality of hook-shaped fasteners.

FIG. 15 is a diagrammatical view of an alternative arrangement of the plurality of hook-shaped fasteners.

FIG. 16 is an exterior perspective view of a cube structure employing a plurality of the panel clamp assemblies interconnecting a plurality of workpiece panels.

FIG. 17 is an interior perspective view of the cube structure shown in FIG. 16.

FIG. 18 is a perspective view of a castle-like structure employing a plurality of the panel clamp assemblies interconnecting a plurality of small workpiece panels and a plurality of large workpiece panels.

FIG. 19 is a perspective view of a third exemplary embodiment of the panel clamp assembly of the present invention having a modified primary panel clamp and a modified secondary panel clamp releasably connected together.

FIG. 20 is an exploded perspective view of the third exemplary embodiment of the panel clamp assembly in FIG. 19 having the modified primary panel clamp and the modified secondary panel clamp disconnected from one another.

FIG. 21 is a top planar view of the modified secondary panel clamp.

FIG. 22 is a side elevational view of the modified secondary panel clamp.

### DETAILED DESCRIPTION OF THE EXEMPLARY EMBODIMENTS

Hereinafter, embodiments of the present invention will be described with reference to the attached drawings. The structural components common to those of the prior art and the structural components common to respective embodiments of the present invention will be represented by the same symbols and repeated description thereof is omitted.

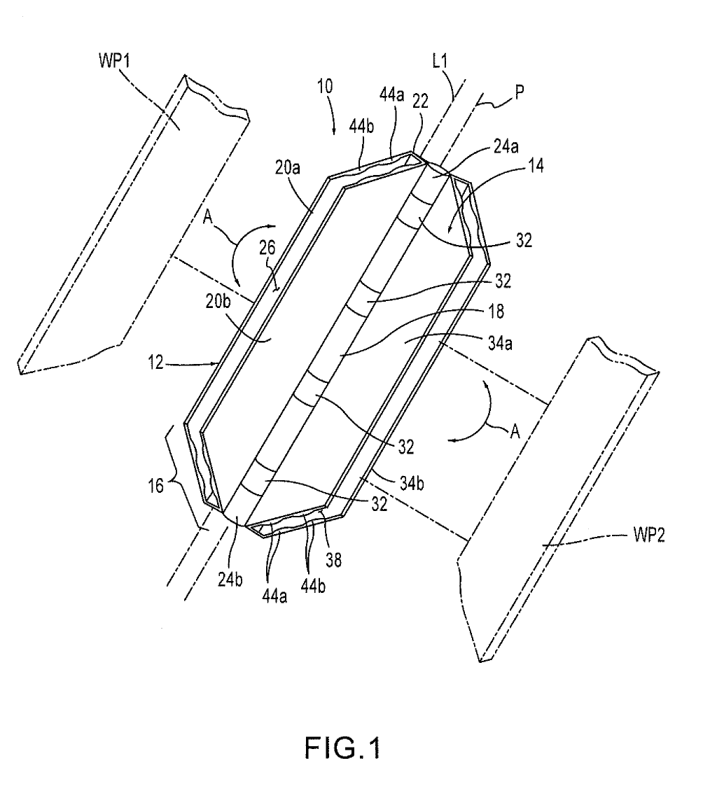

A first exemplary embodiment of a panel clamp assembly 10 of the present invention is generally introduced in FIGS. 1-10. The panel clamp assembly 10 includes a primary panel clamp 12 and at least one secondary panel clamp 14 releasably connected to the primary panel clamp 12. Additional secondary panel clamps to be releasably-connected to the primary panel clamp 12 are discussed below as the second exemplary embodiment of the present invention.

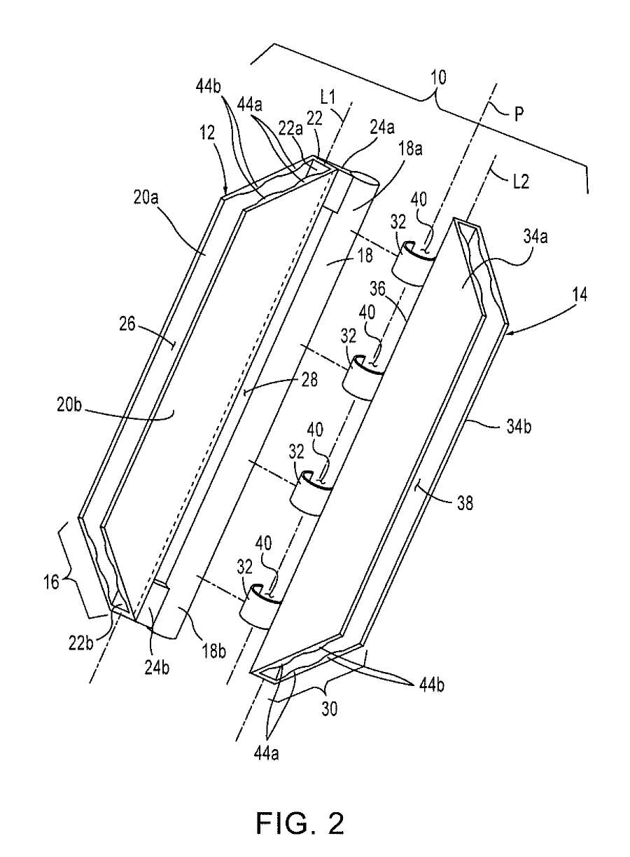

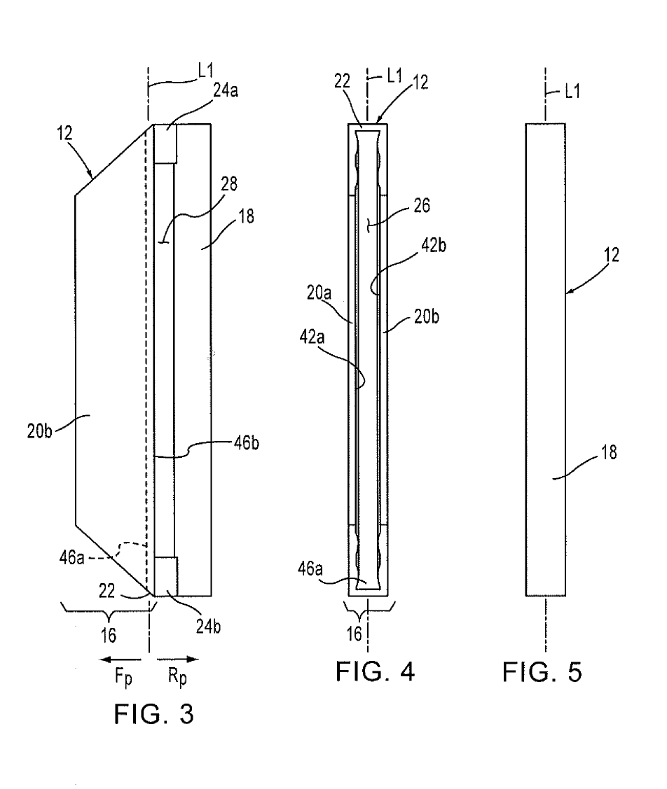

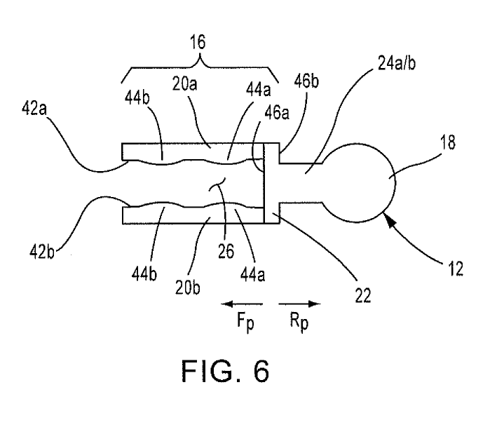

As shown in FIGS. 1-6, the primary panel clamp 12 includes a primary panel clamp member 16 and a support member 18. For the first exemplary embodiment of the panel clamp assembly 10, the support member 18 is a cylindrical rod. The primary panel clamp member 16 extends along and about a first longitudinal axis L1 and has a pair of primary panel jaws 20a and 20b and a primary panel web 22. Also, the primary panel claim 12 includes a pair of connector elements 24a and 24b. For reference purposes only, the first longitudinal axis L1 extends centrally through the primary panel web 22. The primary panel web 22 interconnects the pair of primary panel jaws 20a and 20b to each other in a manner to form a generally U-shaped configuration (as best shown as a square-shaped, sideways U in FIG. 6) and to define a channel 26 between and among the pair of primary panel jaws 20a and 20b and the primary panel web 22. In FIGS. 2 and 3, the pair of connector elements 24a and 24b are disposed apart from one another and connected to the primary panel web 22.

With reference to FIGS. 2, 3 and 5, the support member 18 extends longitudinally and parallel to the primary panel web 22. Also, the support member 18 is connected adjacent the primary panel web 22 in a spaced-apart manner forming a space 28 therebetween as best shown in FIGS. 2 and 3. Again, in FIGS. 2 and 3, the pair of connector elements 24a and 24b interconnects the support member 18 and the primary panel clamp member 16. As illustrated in FIG. 2, the support member 18 has a support member proximal end portion 18a and an opposing support member distal end portion 18b and the primary panel web 22 has a primary panel web proximal end portion 22a and an opposing primary panel web distal end portion 22b. As a result, one connector element 24a interconnects the support member 18 and the primary panel web 22 at respective proximal end portions (18a and 22a) and a remaining connector element 24b interconnects the support member 18 and the primary panel web 22 at respective distal end portions (18b and 22b). The interconnected support member 18 and the primary panel web 22 define the space 28 between and among the support member 18, the primary panel web 22 and the pair of connector elements 24a and 24b.

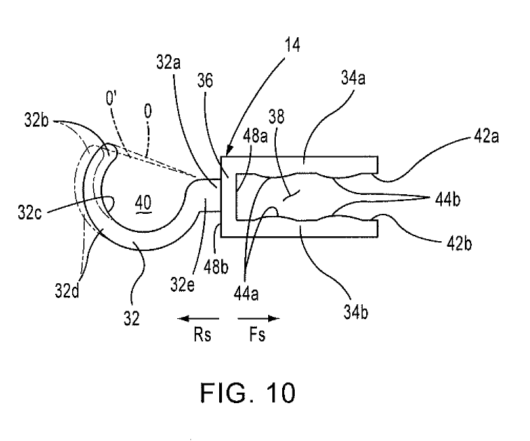

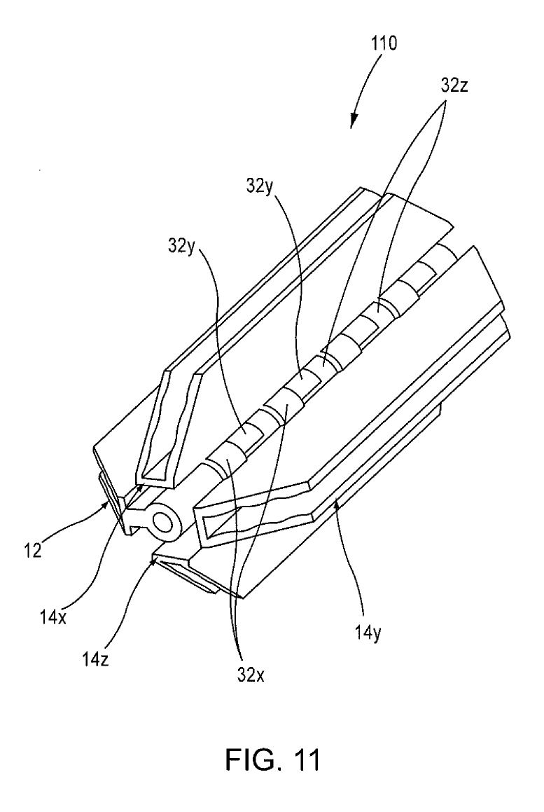

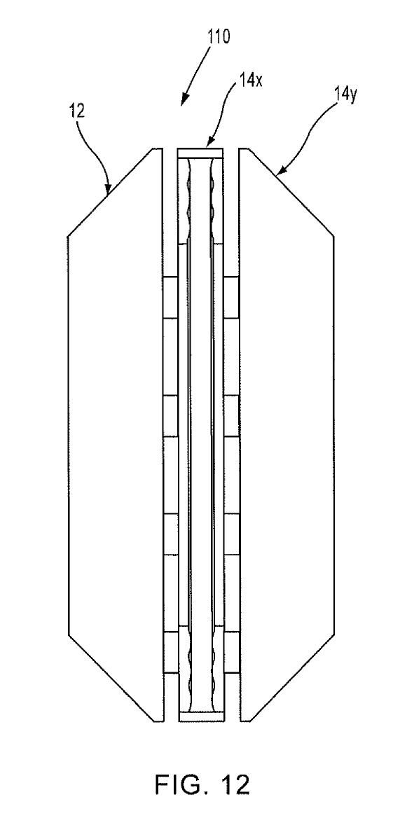

For simplicity of explanation, the at least one secondary panel clamp 14 will hereinafter be referred to as the secondary panel clamp 14. In FIGS. 1, 2 and 7-10, the secondary panel clamp 14 includes a secondary panel clamp member 30 and a plurality of hook-shaped fasteners 32. As discussed hereinafter, one of ordinary skill in the art would appreciate the secondary panel claim 14 includes at least one hook-shaped fastener 32 although a plurality of hook-shaped fasteners 32 are illustrated. The secondary panel clamp member 30 extends along and about a second longitudinal axis L2 which extends parallel to the first longitudinal axis L1. The secondary panel clamp member 30 has a pair of secondary panel jaws 34a and 34b and a secondary panel web 36. The secondary panel web 36 interconnects the pair of secondary panel jaws 34a and 34b to each other in a manner to form a generally U-shaped configuration (as best shown in FIG. 10 as a square, sideways U-shape). The interconnected secondary panel web 36 and the pair of secondary panel jaws 34a and 34b define a channel 38 between and among the pair of secondary panel jaws 34a and 34b and the secondary panel web 36.

With reference to FIG. 10, each hook-shaped fastener 32 has a first end 32a and extends from the first end 32a to terminate in a free end portion 32b. Each hook-shaped fastener 32 has an inner fastener surface 32c that defines a passageway 40. The passageway 40 extends along and about a passageway axis P through the hook-shaped fasteners 32. The first end 32a and the free end portion 32b of each hook-shaped fastener 32 defines an opening O, as best illustrated in FIG. 10, therebetween into the passageway 40. Each hook-shaped fastener 32 is connected to the secondary panel web 36 at the first end 32a as shown in FIG. 10. And, as shown in FIGS. 2 and 7-9, the passageway axis P is oriented parallel to the second longitudinal axis L2. With FIGS. 1 and 2 viewed in combination, each hook-shaped fastener 32 is sized to receive the support member 18 through the opening O and to thereafter releasably retain the support member 18 in the respective passageways 40 in a close-fitting manner.

With reference to FIGS. 2 and 7-9, the plurality of hook-shaped fasteners 32 are disposed apart from one another along the passageway axis P. By way of example only and not by way of limitation, the plurality of hook-shaped fasteners 32 includes at least three hook-shaped fasteners 32. In FIG. 9, by way of example, the plurality of hook-shaped fasteners 32 constitute four (4) hook-shaped fasteners 32 that are spaced apart equidistantly from one another along the passageway axis P at a distance dq.

Again, in FIG. 10, each hook-shaped fastener 32 has an arcuate part 32d that defines the passageway 40 and includes the free end portion 32b. Also, each hook-shaped fastener 32 includes a connector part 32e that interconnects the arcuate part 32d and the secondary panel web 36. As illustrated in FIG. 10, the connector part 32e includes the first end 32a. Each hook-shaped fastener 32 is operative to move to and between a normal, relaxed state (solid line in FIG. 10) and a flexed state (dashed line in FIG. 10). Each hook-shaped fastener 32 is resiliently biased to the normal, relaxed state when the hook-shaped fastener 32 is moved to the flexed state such that, when the hook-shaped fastener 32 moves to the flexed state from the normal, relaxed state, the arcuate part 32d moves to widen the opening O to opening O′ into the passageway 40. As is commonly known in the art, the support member 18 is received by the hook-shaped fastener 32 in this manner.

When the hook-shaped fasteners 32 receive and releasably retain the support member 18 in the passageway 40 in the close-fitting manner as illustrated in FIG. 1, the primary panel clamp 12 and the secondary panel clamp 14 are operative to pivot relative to each other about the passageway axis P as indicated by arcuate arrows A. By way of example only and not by way of limitation, when the hook-shaped fasteners 32 receive and releasably retain the support member 18 in their respective passageways 40 (see FIG. 2) in the close-fitting manner, the plurality of hook-shaped fasteners 32 is disposed between the pair of connector elements 24a and 24b.

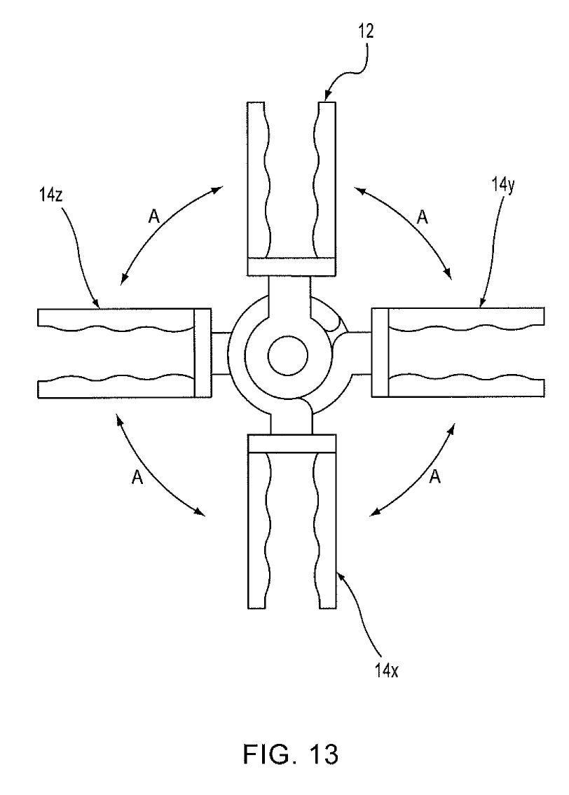

A second exemplary embodiment of a panel clamp assembly 110 of the present invention is illustrated in FIGS. 11-14. The basic difference between first exemplary embodiment of the panel clamp assembly 10 and the second exemplary embodiment of the panel clamp assembly 110 is the number of secondary panel clamps releasably connected to the primary panel clamp 12 and the arrangement of the plurality of hook-shaped fasteners 32 on respective ones of the secondary panel clamps. For the second exemplary embodiment of the panel clamp assembly 110 and by way of example only, there are three secondary panel clamps, namely, a secondary panel clamp 14x, a secondary panel clamp 14y and a secondary panel clamp 14z.

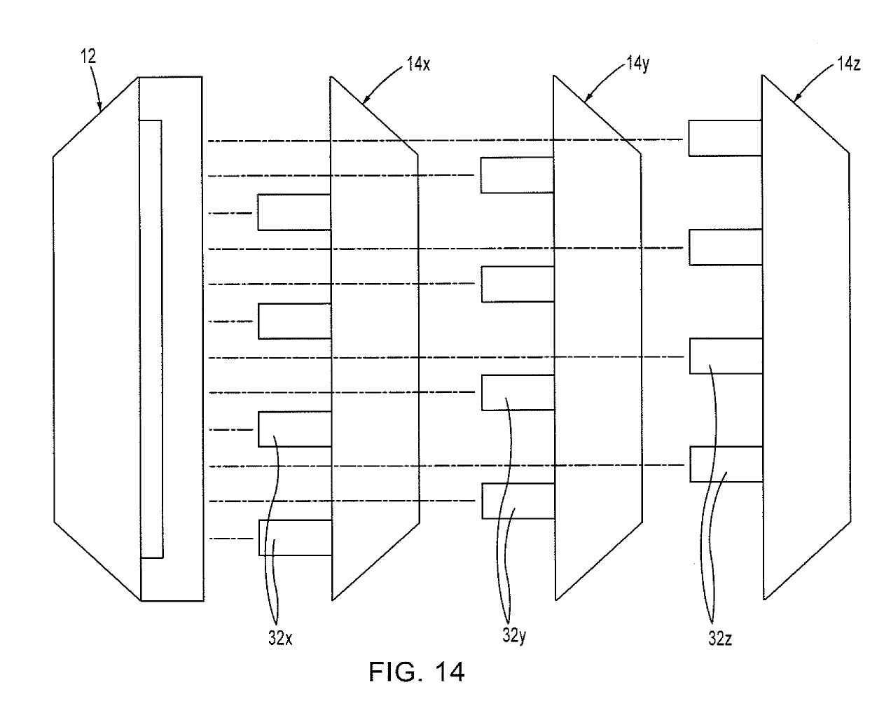

As best shown in FIG. 11 and diagrammatic FIG. 14, the first secondary panel clamp 14x has a plurality of hook-shaped fasteners 32x, the second secondary panel clamp 14y has a plurality of hook-shaped fasteners 32y and the third secondary panel clamp 14z has a plurality of hook-shaped fasteners 32z. As illustrated, respective ones of the plurality of hook-shaped fasteners 32x, 32y and 32z are arranged consecutively in an x-y-z order, more particularly and repetitively as x-y-z, x-y-z, x-y-z and x-y-z, along the passageway axis P.

One of ordinary skill in the art would appreciate that by removing one secondary panel clamp, for instance, the secondary panel clamp 14z, then the remaining ones of the hook-shaped fasteners 32x and 32y are then arranged consecutively in an x-y order, more particularly and repetitively as x-y, x-y, x-y and x-y, along the passageway axis P. In the x-y order, one of ordinary skill in the art would appreciate that the first secondary panel clamp 14x and the secondary panel clamp 14y could slide longitudinally on the support member 18 along the passageway axis P.

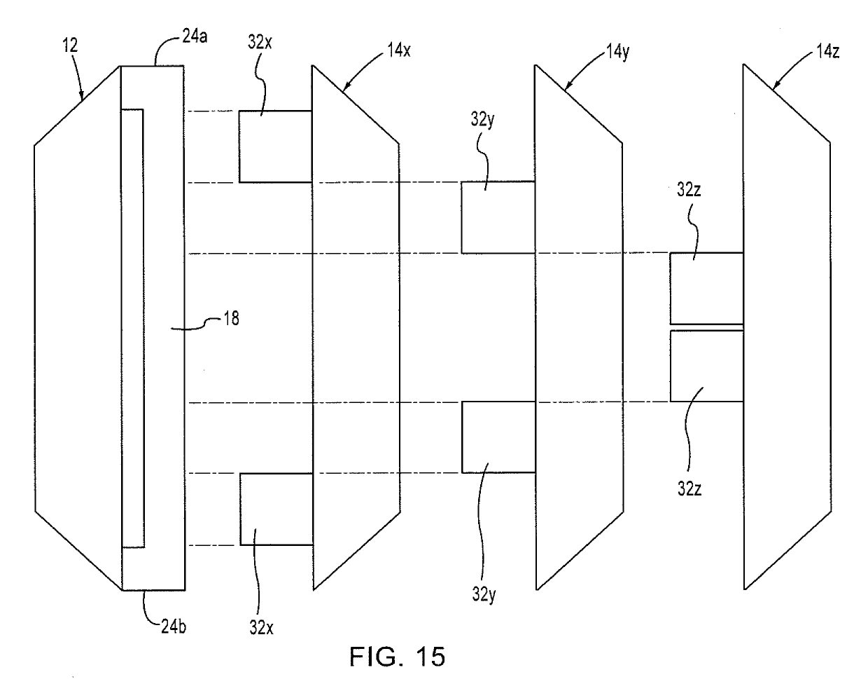

An alternative arrangement forming an x-y-z-y-x order of the hook-shaped fasteners 32x, 32y and 32z is illustrated diagrammatically in FIG. 15. Respective ones of the plurality of hook-shaped fasteners 32x are arranged adjacent respective ones of the connector elements 24a and 24b along the passageway axis P and the pair of hook-shaped fasteners 32y are disposed between respective ones of the hook-shaped fasteners 32x along the passageway axis P. Additionally, the hook-shaped fasteners 32z are disposed between the pair of hook-shaped fasteners 32y along the passageway axis P. However, a skilled artisan would appreciate that instead of a pair of hook-shaped fasteners 32z, it could be just one hooked-shaped fastener 32z.

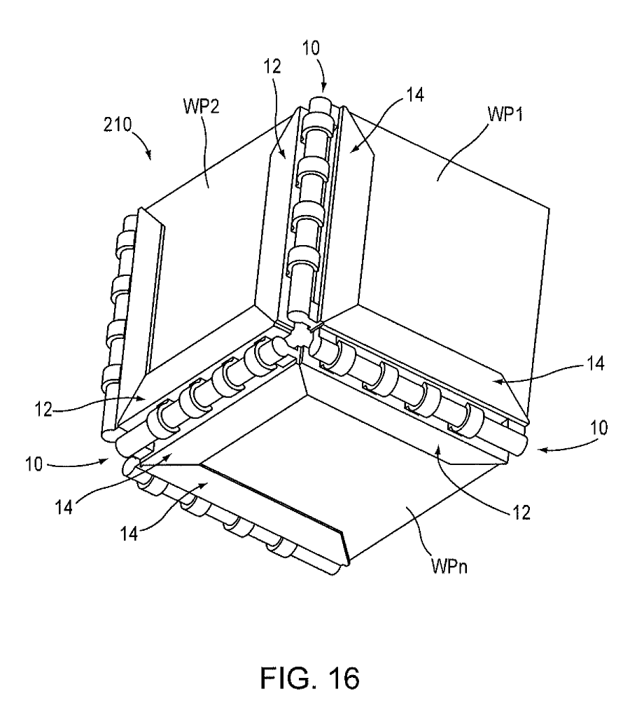

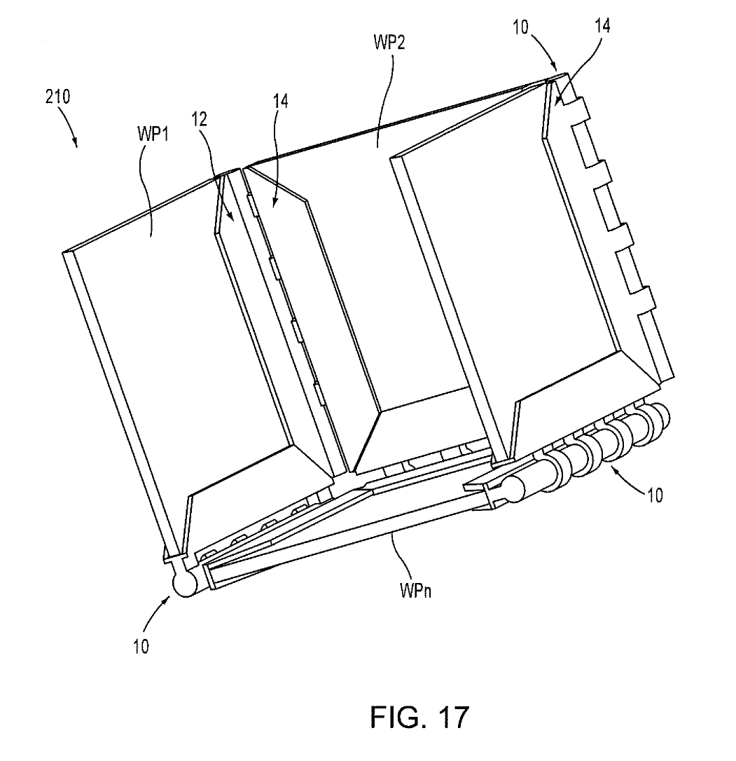

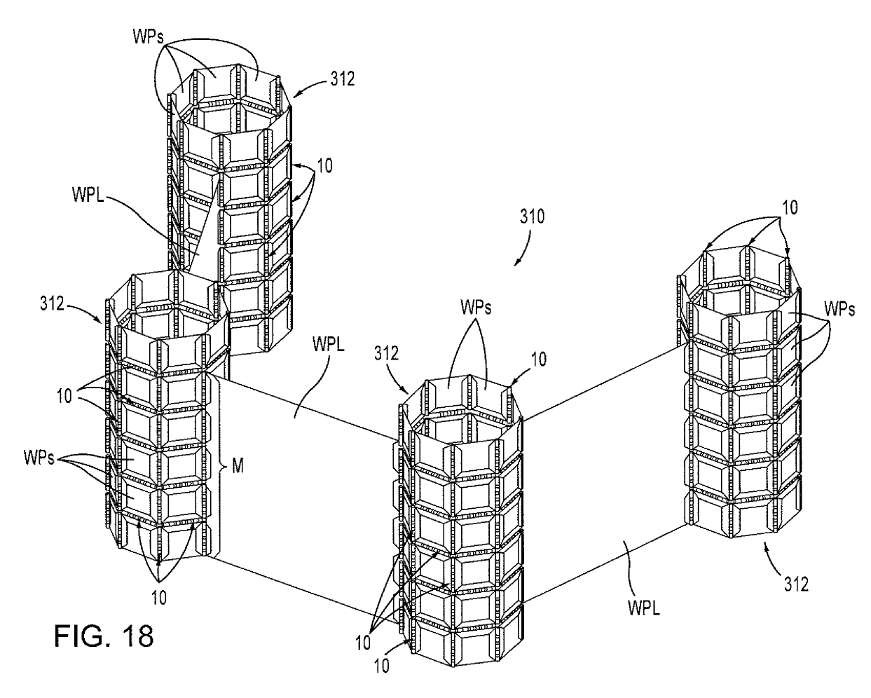

By way of example only, a skilled artisan could use the first exemplary embodiment of the panel clamp assembly 10 as shown in FIGS. 16-18. Workpiece panels WP1, WP2 . . . WPn are received and retained in respective channels 26 and 38 of respective ones of the primary panel clamps 12 and the secondary panel clamps 14 to form a cube-shaped structure 210 as shown in FIGS. 16 and 17. In FIG. 18, a castle-like structure 310 is illustrated showing small workpiece panels WPs received and retained between and among the panel clamp assemblies 10 forming castle-like towers 312 while large workpiece panels WPl are received and retained by a linear series of the panel clamp assemblies 10 shown along location M.

By way of example only and not by way of limitation for the exemplary embodiments of the present invention, one of ordinary skill in the art would appreciate that the primary panel clamp member 16 and the secondary panel clamp member 30 are similar structures. Thus, for simplicity of explanation, the following description of these components will be referred to either as “clamp member” or without the descriptive terms “primary panel” or “secondary panel”.

Respective ones of the pair of jaws 20a and 20b in FIG. 4 (or 34a and 34b in FIG. 8) have inner jaw surfaces 42a and 42b that face each other interiorly of the channel 26 in FIG. 4 (or 38 in FIG. 8). As best shown in FIGS. 6 and 10, respective ones of the pair of jaws 20a and 20b in FIG. 6 (or 34a and 34b in FIG. 10) have a pair of protuberances 44a and 44b that extends longitudinally and projects from respective ones of the inner jaw surfaces 42a and 42b into the channel 26 in FIG. 4 (or 38 in FIG. 10). A skilled artisan would appreciate that at least one protuberance 44a or 44b could be provided on each inner jaw surface 42a and 42b in lieu of a pair of the same.

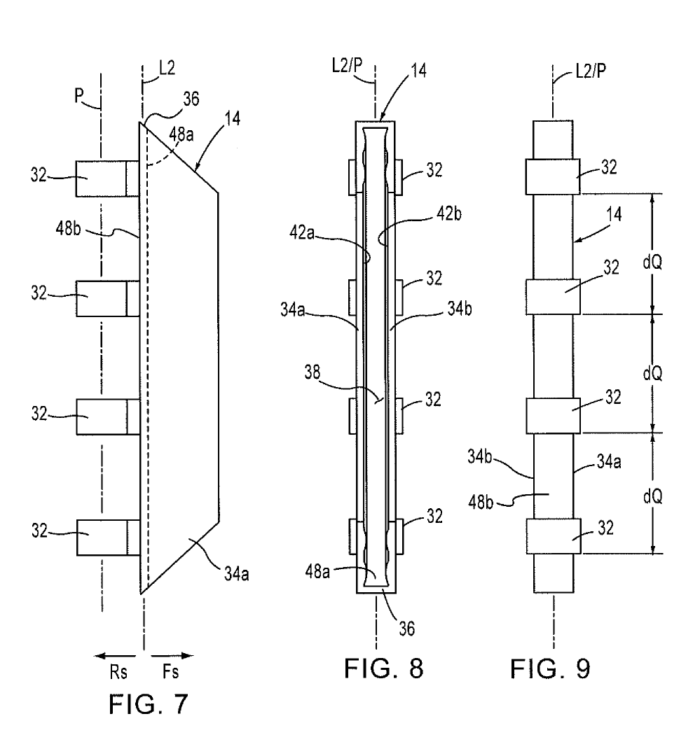

Further, each one of the pair of jaws 20a and 20b in FIG. 6 (or 34a and 34b in FIG. 10) as well as the web 22 in FIG. 6 (or 36 in FIG. 10) are fabricated from a flat plate material. And, each one of the pair of jaws 20a and 20b in FIG. 6 (or 34a and 34b in FIG. 10) has a polygonal facial configuration of a trapezoid as best shown in FIGS. 3 and 7 although a skilled artisan would appreciate that other polygonal facial configurations might be employed.

As shown in FIGS. 3, 4 and 6, the primary panel web 22 includes a primary panel inside web surface 46a and an opposite primary panel outside web surface 46b. The primary panel inside web surface 46a, in part, defines the channel 26. For reference purposes, the primary panel inside web surface 46a is considered to face forwardly in a forward direction illustrated by arrow Fp and the primary panel outside web surface 46b is considered to face rearwardly in a rearward direction illustrated by arrow Rp. Although not by way of limitation, the connector elements 24a and 24b extend rearwardly in the rearward direction Rp from the primary panel outside web surface 46b and, therefore, the support member 18 is disposed rearwardly and projects in the rearward direction Rp relative to the primary panel clamp member 16.

Likewise, as shown in FIGS. 7-10, the secondary panel web 36 includes a secondary panel inside web surface 48a and an opposite secondary panel outside web surface 48b. The primary panel inside web surface 48a, in part, defines the channel 38. For reference purposes, the secondary panel inside web surface 48a is considered to face forwardly in a forward direction Fs and the secondary panel outside web surface 46a is considered to face rearwardly in a rearward direction Rs. Although not by way of limitation, the plurality of hook-shaped fasteners 32 extend rearwardly from the secondary panel outside web surface 48b and, therefore, the hook-shaped fasteners 32 are disposed rearwardly of the secondary panel clamp member 30.

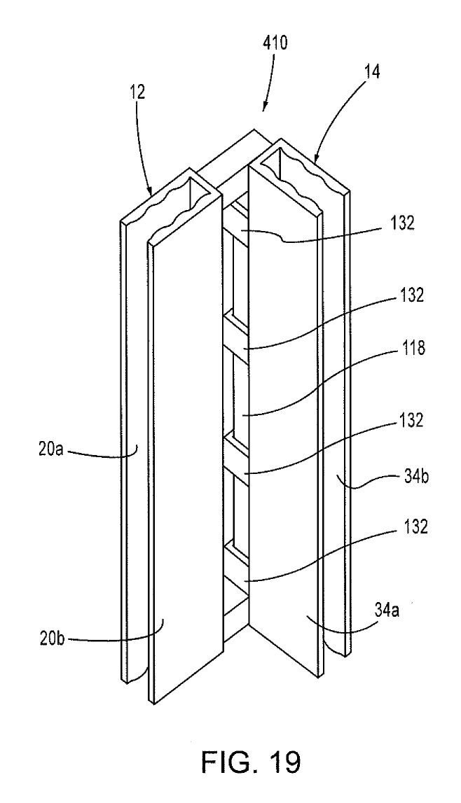

In FIGS. 19-22, a third exemplary embodiment of a panel clamp assembly 410 is similar to the first exemplary embodiment of the panel clamp assembly 10 except for a support member 118 and a plurality of the hook-shaped fasteners 132. Further, rather than having trapezoidal-shaped jaws 20a, 20b, 34a and 34b, the jaws 20a, 20b, 34a and 34b are configured as rectangles.

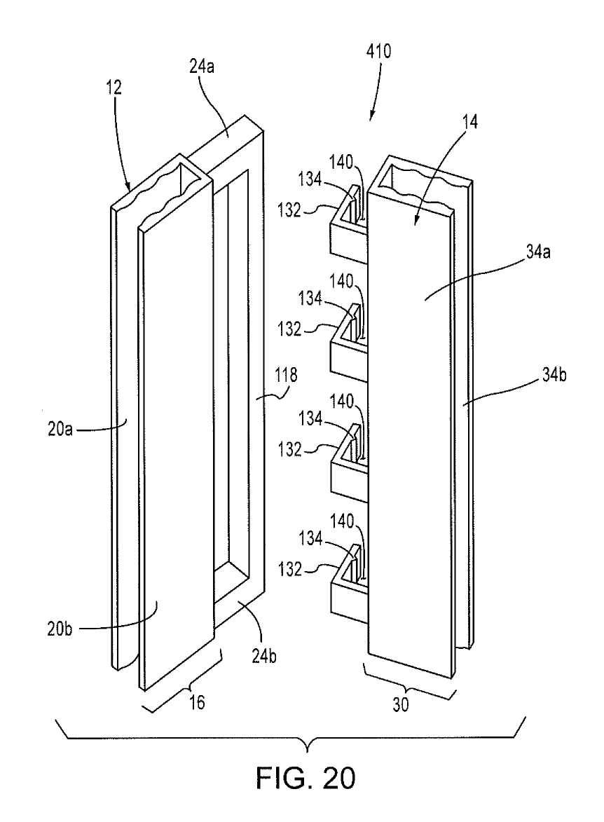

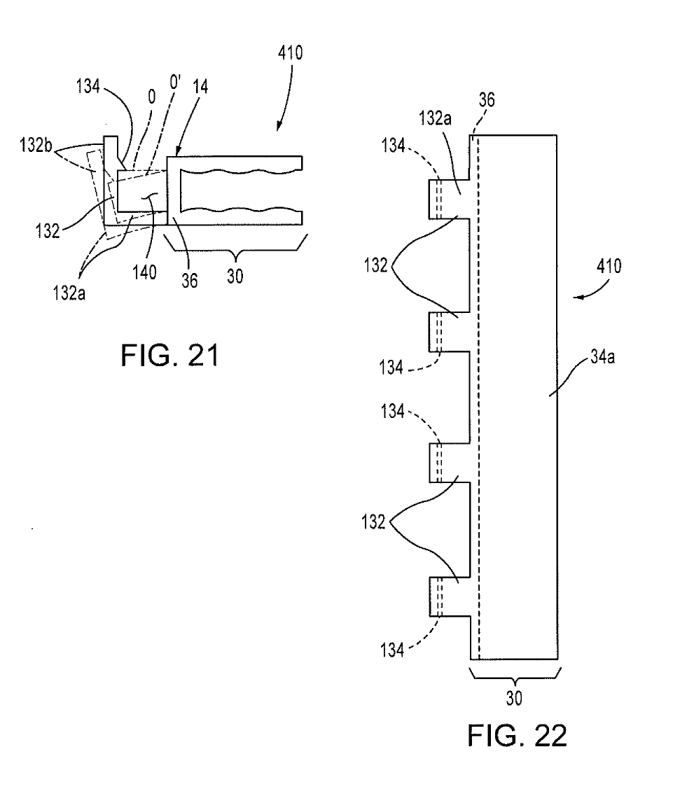

As depicted in FIG. 20, the support member 118 is a rectangularly-shaped rod. As best shown in FIGS. 20 and 21, each hook-shaped fastener 132 has an L-shaped configuration and has a first leg 132a, a second leg 132b connected perpendicularly to each other and a pawl 134 defining a rectangularly-shaped passageway 140 sized to receive the support member 118 is a close-fitting relationship. The first leg 132a interconnects the second leg 132b and the secondary panel web 36 in FIG. 21. As shown in FIG. 21, the pawl 134 is connected to the second leg 132b and projects towards the secondary panel web 36. The opening O extends between the pawl 134 and the secondary panel web 36.

As best shown in FIG. 21, each hook-shaped fastener 132 is operative to move to and between a normal, relaxed state (solid line) and a flexed state (dashed line). Each hook-shaped fastener 132 is resiliently biased to the normal, relaxed state (solid line) when moved to the flexed state (dashed line) such that, when each hook-shaped fastener 132 moves to the flexed state from the normal, relaxed state, the pawl 134 moves away from the secondary panel web 36 to widen the opening O to the opening O′ into the passageway 140. As reflected in FIG. 19, when the plurality of hook-shaped fasteners 132 receives and releasably retains the support member 118 in the passageway 140 in the close-fitting manner, the primary panel clamp 12 and the secondary panel clamp 14 are fixed in a stationary position relative to each other.

It is preferred for all of the embodiments of the present invention that the primary panel clamp member 16, the support member 18 and the pair of connector elements 24a and 24b are fabricated as an integral construction and from a stiff yet pliable material such as plastic or resin. Correspondingly, it is preferred for all of the embodiments of the present invention that the secondary panel clamp member 30 and the at least one hook-shaped fastener 32 are fabricated as an integral construction and from a stiff yet pliable material such as plastic or resin.

The present invention, may, however, be embodied in various different forms and should not be construed as limited to the exemplary embodiments set forth herein; rather, these exemplary embodiments are provided so that this disclosure will be thorough and complete and will fully convey the scope of the present invention to those skilled in the art.

What is claimed is:

1. A primary panel clamp, comprising:
a clamp member extending along and about a longitudinal axis and having a pair of jaws and a web interconnecting the pair of jaws to each other in a manner to form a generally U-shaped configuration and to define a channel between and among the pair of jaws and the web; and
a support member extending longitudinally and parallel to the web, the support member being connected adjacent the web in a spaced-apart manner.

2. A primary panel clamp according to claim 1, further comprising a pair of connector elements disposed apart from one another and interconnecting the support member and clamp member at the web.

3. A primary panel clamp according to claim 2, wherein respective ones of the support member and the web have a proximal end portion and an opposing distal end portion, one connector element interconnects the support member and the web at respective proximal end portions and a remaining connector element interconnects the support member and the web at respective distal end portions to define a space between and among the support member, the web and the pair of connector elements.

4. A primary panel clamp according to claim 1, wherein respective ones of the pair of jaws have inner jaw surfaces facing each other interiorly of the channel and respective ones of the pair of jaws have at least one protuberance extending longitudinally and projecting from respective ones of the inner jaw surfaces into the channel.

5. A primary panel clamp according to claim 1, wherein the support member is one of a cylindrical rod and a rectangularly-shaped rod.

6. A secondary panel clamp, comprising:
a clamp member extending along and about a longitudinal axis and having a pair of jaws and a web interconnecting the pair of jaws to each other in a manner to form a generally U-shaped configuration and to define a channel between and among the pair of jaws and the web; and
at least one hook-shaped fastener having a first end and extending therefrom to terminate in a free end portion, the at least one hook-shaped fastener having an inner fastener surface defining a passageway extending along and about a passageway axis through the hook-shaped fastener with an opening into the passageway, the hook-shaped fastener connected to the web at the first end, the passageway axis oriented parallel to the longitudinal axis.

7. A secondary panel clamp according to claim 6, wherein the at least one hook-shaped fastener has an arcuate part defining the passageway and including the free end portion.

8. A secondary panel clamp according to claim 7, wherein the at least one hook-shaped fastener includes a connector part interconnecting the arcuate part and the secondary panel web, the connector part including the first end.

9. A secondary panel clamp according to claim 7, wherein the hook-shaped fastener is operative to move to and between a normal, relaxed state and a flexed state with the at least one hook-shaped fastener being resiliently biased to the normal, relaxed state when moved to the flexed state such that, when the hook-shaped fastener moves to the flexed state from the normal, relaxed state, the arcuate part moves to widen the opening into the passageway.

10. A secondary panel clamp according to claim 6, wherein the at least one hook-shaped fastener has an L-shaped configuration and has a first leg, a second leg connected perpendicularly to each other and a pawl defining a rectangularly-shaped passageway, the first leg interconnecting the second leg and the web, the pawl connected to the second leg and projecting towards the web, the opening extending between the pawl and the web.

11. A secondary panel clamp according to claim 10, wherein the at least one hook-shaped fastener is operative to move to and between a normal, relaxed state and a flexed state with the at least one hook-shaped fastener being resiliently biased to the normal, relaxed state when moved to the flexed state such that, when the hook-shaped fastener moves to the flexed state from the normal, relaxed state, the pawl moves away from the web to widen the opening into the passageway.

12. A secondary panel clamp according to claim 10, wherein the at least one hook-shaped fastener is a plurality of hook-shaped fasteners disposed apart from one another along the passageway axis.

13. A secondary panel clamp according to claim 10, wherein the at least one hook-shaped fastener is at least three hook-shaped fasteners spaced apart equidistantly from one another along the passageway axis.

14. A primary panel clamp according to claim 6, wherein respective ones of the pair of jaws have inner jaw surfaces facing each other interiorly of the channel and at least one protuberance extends longitudinally and projects from the inner jaw surface of each inner jaw into the channel.

15. A panel clamp assembly, comprising:
a primary panel clamp including:
a primary panel clamp member extending along and about a first longitudinal axis and having a pair of primary panel jaws and a primary panel web, the primary panel web interconnecting the pair of primary panel jaws to each other in a manner to form a generally U-shaped configuration and to define a channel between and among the pair of primary panel jaws and the primary panel web;
a pair of connector elements disposed apart from one another and connected to the primary panel web; and
a support member extending longitudinally and parallel to the primary panel web, the support member being connected adjacent the primary panel web in a spaced-apart manner with the pair of connector elements interconnecting the support member and primary panel clamp member;
and
at least one secondary panel clamp including:
a secondary panel clamp member extending along and about a second longitudinal axis extending parallel to the first longitudinal axis and having a pair of secondary panel jaws and a secondary panel web interconnecting the pair of secondary panel jaws to each other in a manner to form a generally U-shaped configuration and to define a channel between and among the pair of secondary panel jaws and the secondary panel web; and
at least one hook-shaped fastener having a first end and extending therefrom to terminate in a free end portion, the at least one hook-shaped fastener having an inner fastener surface defining a passageway extending along and about a passageway axis through the hook-shaped fastener with an opening into the passageway, the at least one hook-shaped fastener connected to the secondary panel web at the first end, the passageway axis oriented parallel to the second longitudinal axis,
wherein the at least one hook-shaped fastener is sized to receive the support member through the opening and releasably retain the support member in the passageway in a close-fitting manner.

16. A panel clamp assembly according to claim 15, wherein, when the at least one hook-shaped fastener receives and releasably retains the support member in the passageway in the close-fitting manner, the primary panel clamp and the at least one secondary panel clamp are operative to pivot relative to each other about the passageway axis.

17. A panel clamp assembly according to claim 15, wherein, when the at least one hook-shaped fastener receives and releasably retains the support member in the passageway in the close-fitting manner, the primary panel clamp and the secondary panel clamp are fixed in a stationary position relative to each other.

18. A panel clamp assembly according to claim 15, wherein, the at least one hook-shaped fastener is a plurality of hook-shaped fasteners and, when the plurality of hook-shaped fasteners receives and releasably retains the support member in the respective passageways in the close-fitting manner, the plurality of hook-shaped fasteners is disposed between the pair of connector elements.

19. A panel clamp assembly according to claim 18, wherein, the at least one secondary panel clamp includes a first secondary panel clamp having a plurality of hook-shaped fasteners x and a second secondary panel clamp having a plurality of hook-shaped fasteners y with the plurality of hook-shaped fasteners arranged consecutively in an order of x-y along the passageway axis.

20. A panel clamp assembly according to claim 19, wherein, the at least one secondary panel clamp includes a third secondary panel clamp having a plurality of hook-shaped fasteners z with the hook-shaped fasteners arranged consecutively in an order of x-y-z along the passageway axis.

21. A panel clamp assembly according to claim 18, wherein, the at least one secondary panel clamp includes a first secondary panel clamp having a plurality of hook-shaped fasteners x and a second secondary panel clamp having a plurality of hook-shaped fasteners y, respective ones of the plurality of hook-shaped fasteners x being arranged adjacent respective ones of the connector elements and the pair of hook-shaped fasteners y being disposed between respective ones of the hook-shaped fasteners x along the passageway axis.

22. A panel clamp assembly according to claim 21, wherein, the at least one secondary panel clamp includes a third secondary panel clamp having at least one of hook-shaped fastener z with the at least one hook-shaped fastener z being disposed between the pair of hook-shaped fasteners y along the passageway axis.
